(19) United States
(12) Patent Application Publication
(10) Pub. No.: US 2024/0124315 A1
(43) Pub. Date: Apr. 18, 2024

(54) WATER-FREE ETCHING OF MAX PHASES INTO MXENES USING ORGANIC SOLVENTS

(71) Applicant: Drexel University, Philadelphia, PA (US)

(72) Inventors: Michel W. BARSOUM, Moorestown, NJ (US); Varun R. NATU, Philadelphia, PA (US)

(21) Appl. No.: 17/768,245

(22) PCT Filed: Oct. 14, 2020
(86) PCT No.: PCT/US2020/055600

§ 371 Date: Apr. 12, 2022

Related U.S. Application Data
(60) Provisional application No. 62/914,591, filed on Oct. 14, 2019.

(51) Int. Cl. C01B 32/921; B01J 4/00; B01J 8/02

(52) U.S. Cl. CPC C01B 32/921; B01J 4/001; B01J 8/0278; C01P 2002/72; C01P 2002/74; C01P 2002/85; C01P 2004/03; C01P 2004/04; C01P 2004/24; H01M 10/054

(57) ABSTRACT

Provided are methods for etching MAX-phase materials to produce MXenes, the etching being accomplished by a salt, one or both of a polar and a non-polar solvent, and optionally a crown ether, the etching also being optionally performed in a water-free or essentially water-free manner. Also provided are related systems and methods.

### CROSS-REFERENCE TO RELATED APPLICATIONS

The present application claims priority to and the benefit of U.S. patent application No. 62/914,591, “Water-Free Etching of MAX Phases Into MXenes Using Organic Solvents” (filed Oct. 14, 2019), the entirety of which application is incorporated herein by reference for any and all purposes.

### GOVERNMENT RIGHTS

This invention was made with government support under Contract No. DMR 1740795 awarded by the Division of Materials Research of NSF. The government has certain rights in the invention.

### TECHNICAL FIELD

The present disclosure relates to the field of MXene materials and to the field of processing such materials.

### BACKGROUND

Since their discovery, MXene materials have shown promise in various applications like energy storage, catalysts for hydrogen evolution reactions, gas sensing, water desalination, reinforcement in polymer composites, EMI shielding, and others. Existing methods of forming MXenes, however, often include water as, which in turn limits the scope of these formation methods.

Using water as a solvent, however, poses problems when incorporating MXenes in some applications. For example, certain polymerization reactions are hampered in the presence of water, making synthesis of in-situ polymerized nanocomposites reinforced with MXenes difficult. The synthesis of specific quantum dots on MXenes sheets is also challenging because of the presence of water. Further, even trace amounts of water in Li or Na ion batteries using organic electrolytes can negatively impact their performance, making vacuum annealing of MXene anodes mandatory before cell assembly.

Accordingly, there is a long-felt need for water-free techniques for forming MXene materials.

### SUMMARY

In meeting the described long-felt needs, the present disclosure first provides methods of synthesizing a MXene material, the methods comprising: contacting a MAX-phase material with an etchant, the MAX-phase material comprising elements M, A, and X and having the formula Mₙ₊₁AXₙ, the etchant being free of water, the etchant comprising (i) a salt, (ii) one or both of a polar solvent or a non-polar solvent, and optionally (iii) a crown ether, the contacting being performed under such conditions such that element A is removed from the MAX-phase material so as to give rise to a layered MXene material having the formula Mₙ₊₁XₙT_{z}.

Also provided are layered MXene materials made according to the present disclosure.

Further provided are methods, comprising effecting the reversible insertion of cations between layers of a layered MXene material made according to the present disclosure, the layered MXene material optionally in electronic communication with an electrical load.

Also provided are systems, comprising: a supply of a MAX-phase material; a supply of a salt; a supply of at least one of a polar solvent or a non-polar solvent; optionally, a supply of a crown ether; and a container configured to contain the MAX-phase material, the at least one of a polar solvent or a non-polar solvent, the optional crown ether, and the salt.

Additionally provided are admixtures, comprising: an amount of a MAX-phase material; an amount of at least one of a polar solvent and a non-polar solvent; optionally, an amount of a crown ether; and an amount of a salt, the admixture optionally further comprising an amount of a layered MXene material, and the admixture being free of water.

### BRIEF DESCRIPTION OF THE DRAWINGS

The file of this patent or application contains at least one drawing/photograph executed in color. Copies of this patent or patent application publication with color drawing(s)/photograph(s) will be provided by the Office upon request and payment of the necessary fee.

FIG. 1a provides a starting Ti₃AlC₂ phase (for a schematic of etching and washing steps), FIG. 1B illustrates that after etching with NH₄HF₂ in organic solvent, FIG. 1c provides that after washing in HO/ethanol mixture, and FIG. 1d illustrates a final state. What is illustrated between the layers is only included for the sake of the schematic and in no way should be construed to be what is actually there at this stage.

FIG. 2a provides (XRD patterns of Ti₃C₂T_{z}, synthesized in organic solvents) before washing, right after etching; FIG. 2b is the same as FIG. 2a but focused on 1.2-10° 2θ to clearly show the 002 peaks; FIG. 2c illustrates results after drying and grinding filtered films, FIG. 2d is the same as FIG. 2c, but is focused on low angles. Patterns are shifted vertically for clarity. The molecular structure of the organic solvents used are shown right above the corresponding XRD pattern. Sequence of XRD patterns is same in all 4 panels and corresponds to ACN- (top, yellow), DXN- (second, purple), DMF- (third, green), DMSO- (fourth, blue), NMP- (fifth, red) and PC-MX (sixth, black).

FIG. 3a shows (for a PC-Ti₃C₂T_{z} sample) a typical SEM micrograph; and FIG. 3b shows TEM micrographs of delaminated sheets, wherein the inset shows SAED pattern obtained from flakes shown in (b).

FIG. 4a provides XPS of Ti 2p region for PC-MX samples immediately after etching and washing and, FIG. 4b provides the same after 12 h of exposure to the ambient atmosphere.

FIG. 5a provides electrochemical performance of PC-MX anodes in Na-ion cells via cyclic voltammograms of cells cycled between 0.01 V and 3 V vs. Na/Na⁺ at 0.2 mV s⁻¹. CV curves of the first 10 cycles are shown, FIG. 5b provides cycling performance at a current density of 100 mA g⁻¹ and rate performance at current densities of 20, 50, 100, 200, 500 and 1000 mA g⁻¹.

FIG. 6a provides SEM micrograph of multilayer a) ACN-Ti₃C₂T_{z}, FIG. 6b provides the same for DXN-Ti₃C₂T_{z}, FIG. 6c provides the same for DMF-Ti₃C₂T_{z}, FIG. 6d provides the same for DMSO-Ti₃C₂T_{z}, and FIG. 6e provides the same for NMP-Ti₃C₂T_{z} samples (Scale Bar=1 μm).

FIG. 7a provides XRD patterns of Ti₃C₂T_{z}, synthesized in HF and stirred in corresponding organic solvent for a week, FIG. 7b provides the same as FIG. 7a but focused on 1.2-10° 2θ to clearly show the 002 peaks. The only change in d-spacing was for observed for DMSO.

FIG. 8: Charge-discharge curves of PC-MX anodes in Na ion cells cycled between 0.01-3 V at currents 20 (red), 50 (blue), 100 (green), 200 (purple), 500 (yellow), 1000 (cyan) mA g⁻¹.

FIG. 9: Schematic of crown ethers solvating various cations.

FIG. 10: X-ray diffraction spectrum of Ti₃AlC₂ stirred in different solutions as follows: hexane+NH₄HF₂ (black, top), hexane+NH₄HF₂+CE (blue, second from top), cyclohexane+NH₄HF₂+CE (red, third from top) and toluene+NH₄HF₂+CE (orange, bottom).

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

Since the discovery of 2D titanium carbide (Ti₃C₂T_{z}) MXene, additional MXenes have been discovered so far and more are being routinely discovered. Owing to their chemical diversity, hydrophilicity, 2D morphology and metallic conductivity MXenes have shown promise in various applications like energy storage, catalysts for hydrogen evolution reactions, gas sensing, water desalination, reinforcement in polymer composites, EMI shielding, and many more.

MXenes have a general formula Mₙ₊₁XₙT_{z} and are so called because they are derived by etching the A atomic layers from the parent MAX (Mₙ₊₁AXₙ) phase, where M stands for an early transition metal, A can be (generally) a group 13 or 14 element, and X stands for C and/or N. The -ene suffix was added to make the connection to other 2D materials, like graphene, silicene, etc. The T_{z} in the chemical formula stands for the various —O, —OH, —F surface terminations that replace the Al layers upon etching.

The first MXene discovered was Ti₃C₂T_{z}, obtained by etching Ti₃AlC₂ powders in concentrated hydrofluoric, HF, acid. Even though this is the first way of synthesis, there is a risk of over-etching the MXene leading to its complete dissolution into the acid or creating highly defective flakes with poor electronic properties. Further, it was found that MXenes etched with just HF, could not be delaminated to form stable, high concentration colloids in water, and the MXene multilayers, MLs, needed to be intercalated with molecules like dimethyl sulfoxide (DMSO), tetramethylammonium hydroxide (TMAOH), tetrabutylammonium hydroxide (TBAOH) etc., to achieve delamination.

In short, all near ambient temperature synthesis methods known to date use water as the main solvent. Using water as a solvent, however, poses problems when incorporating MXenes in some applications. For example, certain polymerization reactions are hampered in the presence of water, making synthesis of in-situ polymerized nanocomposites reinforced with MXenes difficult. The synthesis of specific quantum dots on MXenes sheets might also not be possible, again, due to presence of water. Most importantly, it is well established that even trace amounts of water in Li or Na ion batteries using organic electrolytes can negatively impact their performance, making vacuum annealing of MXene anodes mandatory before cell assembly.

Although the instant disclosure describes the use of Ti₃C₂-type MXene because of the convenient ability to prepare larger scale quantities of this material, other MXene compositions are within the scope of this disclosure, e.g., MXene compositions of any of U.S. patent application Ser. No. 14/094,966 (filed Dec. 3, 2013); 62/055,155 (filed Sep. 25, 2014); 62/214,380 (filed Sep. 4, 2015); 62/149,890 (filed Apr. 20, 2015); 62/127,907 (filed Mar. 4, 2015); or International Applications PCT/US2012/043273 (filed Jun. 20, 2012); PCT/US2013/072733 (filed Dec. 3, 2013); PCT/US2015/051588 (filed Sep. 23, 2015); PCT/US2016/020216 (filed Mar. 1, 2016); or PCT/US2016/028,354 (filed Apr. 20, 2016), preferably where the MXene composition comprises titanium and carbon (e.g., Ti₃C₂, Ti₂C, Mo₂TiC₂, etc.). Each of the foregoing is incorporated herein by reference in its entirety for any and all purposes.

The present disclosure provides, inter alia, water-free methods of etching and delaminating MXenes in a variety of solvents (and salts), e.g., in the presence of ammonium dihydrogen fluoride, NH₄HF₂. Ti₃C₂T_{z} synthesized in propylene carbonate, PC, exhibit nearly double the capacity compared to the same MXene etched in water when tested as electrodes in sodium ion batteries, SIB, in a PC containing electrolyte.

The water-free methods and materials provided in the instant disclosure have use in a broad range of applications, e.g., quantum dot applications, perovskite solar cell applications, metal-organic framework composites, polymer composites, and the like. The disclosed methods can also be applied when small/trace amounts of water are present.

Experimental Example Details

The following examples are illustrative only and do not limit the scope of the present disclosure or the appended claims.

MAX Powders

The Ti₃AlC₂ powders were made by mixing titanium carbide, TiC, (Alfa Aesar, 99.5%, 2 μm), aluminum (Alfa Aesar, 99.5%, −325 mesh) and Ti (Alfa Aesar, 99.5%, −325 mesh), powders in a molar ratio of 2:1.05:1, respectively. The mixed powders were ball milled for 24 h at 70 rpm, and then heated under flowing argon (Ar) to 1450° C. for 2 h. The heating and cooling rates were set at 5° C./min. The resulting loosely sintered blocks were ground using a milling bit on a drill press. The milled powders were passed through a 400 mesh (particle size<38 μm) sieve for further experiments. The as-sieved Ti₃AlC₂ powders were transferred to an Ar filled glovebox, for further use.

Etching

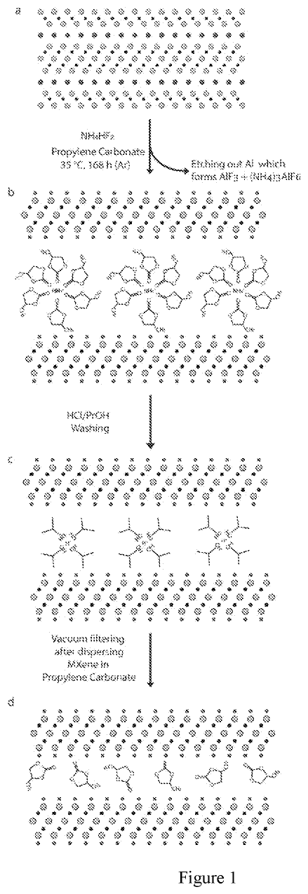

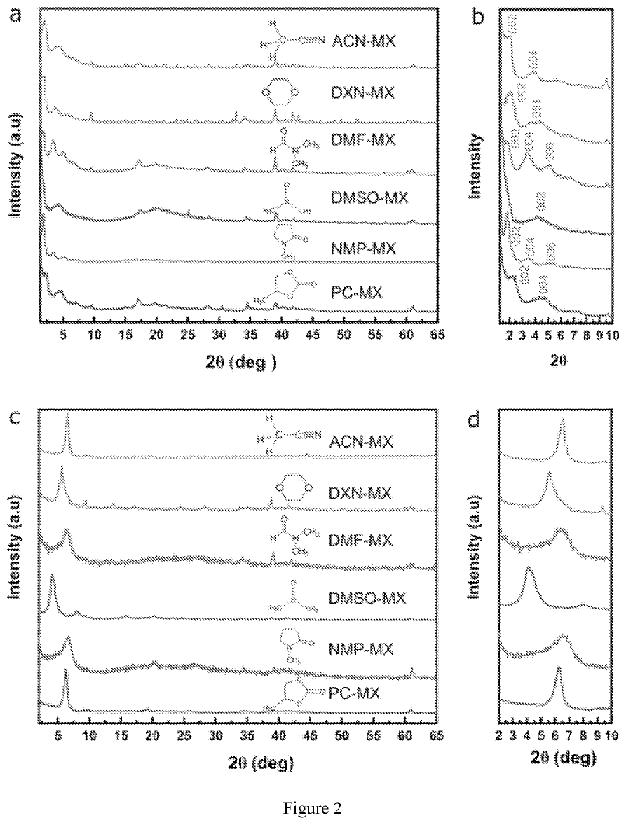

FIG. 1 is a schematic of the etching, washing and film formation procedures used in this work when the solvent was PC. Similar etching procedure was also repeated with other organic solvents listed below. To etch the MAX phase, 1 g of Ti₃AlC₂ was added to 10 mL of the organic electrolyte PC (99.7%, anhydrous, Sigma Aldrich USA), to which finally 1 g of dehydrated ammonium dihydrogen fluoride, NH₄HF₂ (95%, reminder NH₄F, Alfa Aesar, USA) was added. This mixture was stirred at 500 rpm inside the glovebox for 196 h at 35° C. The first set of XRD patterns (FIGS. 2a,b) was taken after this step.

Washing

The slurry was then transferred to an empty 50 mL centrifuge tube and taken out of the glovebox for further washing. The washing step was necessary to remove the reaction products. The remaining volume of the centrifuge tube was then filled with 6 M HCl solution in 2-propanol (>99%, Fisher Scientific, USA), shaken using a vortex mixer for 60 s and centrifuged at 3500 rpm for 120 s. The resulting clear supernatant was discarded, and a fresh acidic propanol solution was added and the same steps as above were repeated. This washing step was repeated a total of 5 times. After this the PC was added to the MXene cake and the tube shaken, using a vortex mixture for 60 s, to homogenize the mixture, and centrifuged again at 3500 rpm for 120 s, after which the clear supernatant was discarded, this process was also repeated a total of 5 times.

Delamination

To delaminate the Ti₃C₂T_{z} multilayers, MLs, into single, to few layers, 30 mL of PC was added to the Ti₃C₂T_{z} slurry and the mixture was sonicated, under flowing Ar, for 1 h while immersed in an ice bath. The so-formed suspension was centrifuged at 3500 rpm for 900 s to separate the delaminated Ti₃C₂T_{z} from the insoluble salts formed during etching and MLs that were not delaminated. The latter process is similar to the one reported by Collini et al. who also used PC as a solvent for delaminating Ti₃C₂T_{z}.^{[21]}

Film Formation

The supernatant Ti₃C₂T_{z} colloid was filtered through a Celgard membrane using a mechanical vacuum pump. The filtered film was vacuum dried overnight and powdered using a mortar and pestle and stored in vials under Ar for further analysis. We note that all these procedures were carried out in an ambient atmosphere. The second set of XRD diffraction patterns were taken after this step.

Similar etching and washing procedures as described above were repeated for other solvents including—all obtained from Sigma Aldrich, USA—dioxane (DXN) (99%, anhydrous,), acetonitrile (ACN) (99.8%, anhydrous), N,N-dimethylformamide (DMF) (99.8%, anhydrous), dimethyl sulfoxide (DMSO) (>99.9%, anhydrous,) and N-Methyl-2-pyrrolidone (NMP) (99.5%, anhydrous). Henceforth, to denote the MXene etched using a particular solvent, the prefix of the solvent abbreviation is added before the acronym, MX. For example, samples synthesized in propylene carbonate are labeled PC-MX; those in acetonitrile ACN-MX, etc.

Solvent Exchange

In an attempt to shed some light on the resulting interlayer spacings observed after etching in the polar solvent, we decided to etch Ti₃AlC₂ in HF and then carry out a solvent exchange. To this effect, first 1 g of Ti₃AlC₂ MAX was added to 10 mL of 10% solution of HF in water. This mixture was stirred overnight for 12 h, after which the slurry was decanted into a 50 mL centrifuge tube and DI water was added to fill the remaining volume. The centrifuge tube was then sealed and shaken for 60 s before centrifuging it at 3500 rpm for 60 s. The MXene sediment at the bottom and the clear acidic supernatant was discarded and DI was added again, and the washing procedure was repeated until the pH of the supernatant reached≈7. After the last washing step the supernatant is discarded and the sedimented MXene is collected and air dried. Lastly, 200 mg of the air dried powder is added to 40 mL of one of the organic solvents listed above and the bottle was then sealed with parafilm and the mixture stirred for 1 week at room temperature. After stirring, the mixture is again transferred to a centrifuge tube and centrifuged at 3500 rpm for 60 s, the clear organic solvent supernatant is discarded and the MXene sediment is immediately used for XRD analysis. Similar to the nomenclature above, the MXene etched in water and HF solution is labelled as Water-MX.

Characterization

X-ray diffraction (XRD) patterns were acquired on a diffractometer (Rigaku Miniflex, Tokyo, Japan) using Cu K_{α} radiation (40 kV and 40 mA) with a step size of 0.02° and dwell time of 1.5 s, in the 1.5-65° 2θ range.

A scanning electron microscope (SEM) (Zeiss Supra 50VP, Germany) with an inlens detector and 30 μm aperture was used to examine the morphology and obtain micrographs of the samples.

To collect XPS spectra, Al-Kα X-rays with a spot size of 200 μm and pass energy of 23.5 eV were used to irradiate the sample surface. A step size of 0.5 eV was used to gather the high-resolution spectra. CasaXPS Version 2.3.19PR1.0 software was used for spectra analysis. The XPS spectra were calibrated by setting the valence edge to zero, which was calculated by fitting the valence edge with a step down function and setting the intersection to 0 eV. Because MXenes are electrically conductive, all MXene peaks were fit using an asymmetric Lorentzian line shape. The background was determined using the Shirley algorithm which is a built-in function in the CasaXPS software.

To analyze individual MXene flakes, a TEM (JEOL 2100 LaB₆, Tokyo, Japan) was used in bright-field mode. The accelerating voltage was set to 200 kV. To prepare TEM samples, a colloid drop was cast onto a lacy carbon coated copper grid (Cu-400LC, Pacific Grid-Tech) and dried under vacuum again under an ambient atmosphere.

To prepare our electrodes, the PC-MX powder was mixed with Super P Conductive carbon (Alfa Aesar, USA) and polyvinylidene fluoride (PVDF) (MTI chemicals, USA) binder in a weight ratio of 70:20:10 in nominal N-Methyl-2-pyrrolidone (NMP) (TCI, USA). This slurry was then cast on an Al foil using a doctor blade and dried in a vacuum oven overnight at 40° C. to evaporate the NMP. Circular disc electrodes (Ø11 mm) were punched out and CR-2032 coin cells were assembled in an Ar filled glove box (MBraun Labstar H₂O and 02<1 ppm). Sodium metal served as both counter and reference electrodes. Ethylene carbonate (EC): propylene carbonate (PC, 1:1 v/v) with 5% fluoroethylene carbonate (FEC) with 1M NaClO₄ salt dissolved in it was used as electrolyte. In all cases, the electrodes were cycled between 0.01 V and 3 V vs. Na/Na⁺. For all the electrochemical results shown herein, the capacity was normalized by the weight of the MXene only.

Results and Discussion

FIG. 2a plots the XRD patterns of as-etched MXene just before washing, while FIG. 2c plots the XRD patterns after delamination followed by filtering and grinding. FIGS. 2b and d focus on the low angle region. The sequence of the patterns is the same in all 4 panels with ACN-MX (top, yellow), DXN-MX (second, purple), DMF-MX (third, green), DMSO-MX (fourth, blue), NMP-MX (fifth, red), PC-MX (last, black). FIG. 2b shows highly expanded basal spacings which can be determined from the position of the 002 peak present near 2° 2θ for all samples except DMSO-MX for which the 002 peak was around 4.2° 2θ. The exact d-spacings calculated are given in Table 1. The d-spacings of 21-51 Å found in all the samples are significantly higher compared to the d-spacing of 12.3 Å obtained by Halim et al., who etched Ti₃AlC₂ thin films in NH₄HF₂ and water. This suggests that during etching in organic solvents the interlayer space is most probably occupied by NH₄⁺ cation complexes associated with organic solvent molecules and not bare cations.

Without being bound to any particular theory, it is difficult to explain the small differences seen in d-spacings, especially in the case of DMSO-MX where the d-spacing was found to be smaller than all other cases (Table 1). When etching Ti₃AlC₂ powders phase in LiF+HCl solutions, even though the cations are intercalated between the layers during etching they are not hydrated at the acidic pH of the etching solutions and the interlayer swelling and complete hydration of the cations only occurs upon washing the MXene to neutral pH. But this does not seem to be the case when etching in NH₄HF₂ and organic solvents as sharp high-intensity peaks at low angles are seen in the XRD patterns before washing, implying significant differences in the etching and/or intercalation processes in water and organic solvents.

The small peak around 9° 2θ seen in the ACN-MX, DMF-MX, DXN-MX and PC-MX samples corresponds to leftover Ti₃AlC₂ powders that were not completely etched.

FIGS. 2c and d show XRD patterns of filtered films after grinding. No other peaks other than those corresponding to MXene are seen in all but the DXN-MX sample (FIG. 2d). The small peak around 9° 2θ, seen only in the DXN-MX sample, is again due to unetched MAX particles.

It is important to note that because organics solvents used herein have low solubilities for the Al-salts formed during etching, they could not be washed away without the use of acidic propanol. Somewhat surprisingly, after washing, the d-spacings reduce significantly and range between 13.5-21 Å (column 3, Table 1). The most probable cause of this reduction is the exchange of ammonium cations with protons present in the acidic ethanol. This is consistent with earlier work on cation exchange in MXenes etched in water^{[25]}, but is observed here to occur, for the first time, in multiple polar solvents other than water. Interestingly, the d-spacing of DMSO-MX sample remains constant at ≈21 Å before and after washing implying no cationic exchange in this case.

When solvent exchange was done in kaolinite clays, it was found that upon interaction with DMF, NMP and ACN there is 4-5 Å increase in the d-spacing compared to dry kaolinite.^{[26,27]} This might explain the ≈4.5 Å increase in the washed ACN-MX, NMP-MX and DMF-MX compared to dry proton intercalated Ti₃C₂T_{z}, indirectly proving the presence of the corresponding organic solvents between the MXene layers. The 14 Å d-spacing in the washed PC-MX matches the work on electrophoretic deposition of Ti₃C₂T_{z} MXene in a PC electrolyte, and indirectly confirms the presence of PC between the MXene layers in the PC-MX films.

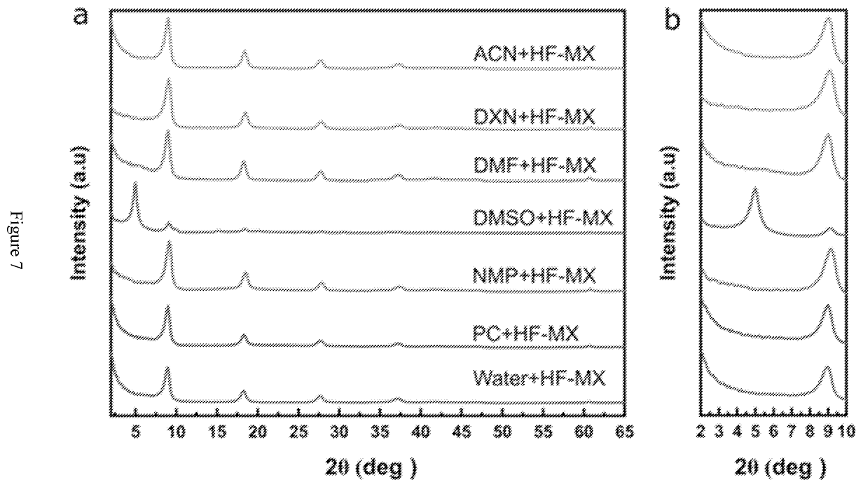

FIG. 7, presents the XRD patterns of the samples that were first etched in HF and water and then solvent exchanged for a week. FIG. 7 shows, that except for DMSO no other solvent intercalated between the MXene sheets, further highlighting the importance of the etching method presented in this work.

TABLE 1
Lists the d-spacings of all the samples calculated from the position
of 002 peak. The 2^{nd} column lists the d-spacing values before washing
right after etching; the last column lists the values after drying
and grinding the filtered films obtained after washing. The numbers
outside the bracket denote the d-spacing in Å and the values
in bracket show the 2θ angle at which the 002 peak is located.

d-spacing, Å, (2θ)

| Sample | Before washing | After washing |
|---|---|---|
| ACN-MX | 45.0 (2.0) | 13.5 (6.5) |
| DXN-MX | 41.9 (2.1) | 15.7 (5.6) |
| DMF-MX | 50.7 (1.7) | 13.5 (6.5) |
| DMSO-MX | 21.1 (4.2) | 21.2 (4.1) |
| NMP-MX | 48.7 (1.8) | 13.5 (6.5) |
| PC-MX | 39.0 (2.2) | 14.0 (6.3) |

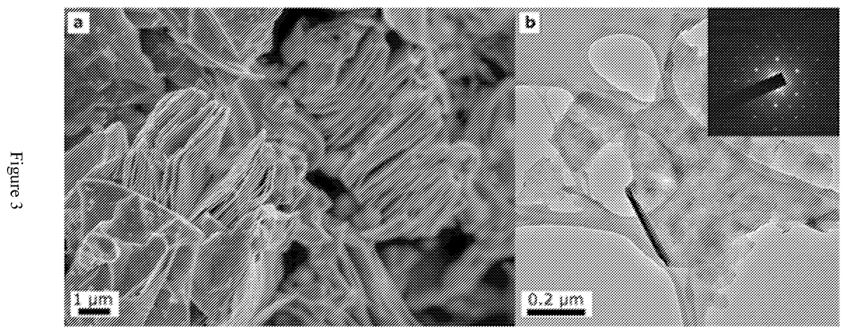

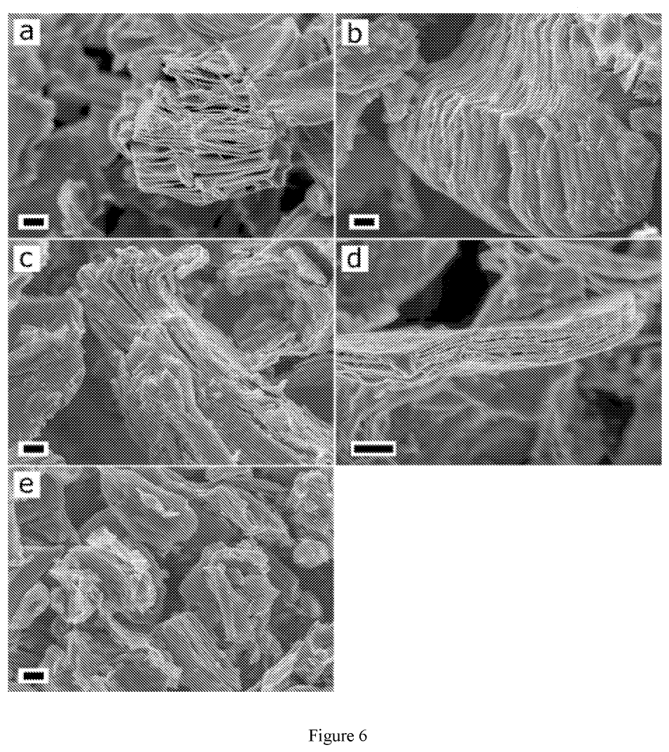

FIG. 3a shows typical SEM micrographs of a PC-MX sample after washing before delamination. The accordion-like morphology is typical of etched Ti₃AlC₂ powders and further confirms the successful synthesis of Ti₃C₂T_{z}. Similar morphologies were also observed in MXenes synthesized in other solvents (FIGS. 6a-e). FIG. 3b is a typical TEM micrograph of a Ti₃C₂T_{z} flakes obtained after sonicating the multilayers. Selected area diffraction (SAED) pattern (inset FIG. 3b), further confirms the presence of Ti₃C₂T_{z} monolayers. One can thus delaminate Ti₃C₂T_{z} MLs using the procedure outlined in this work. (There is little evidence for TiO₂ nanoparticles on the surface of the flake.)

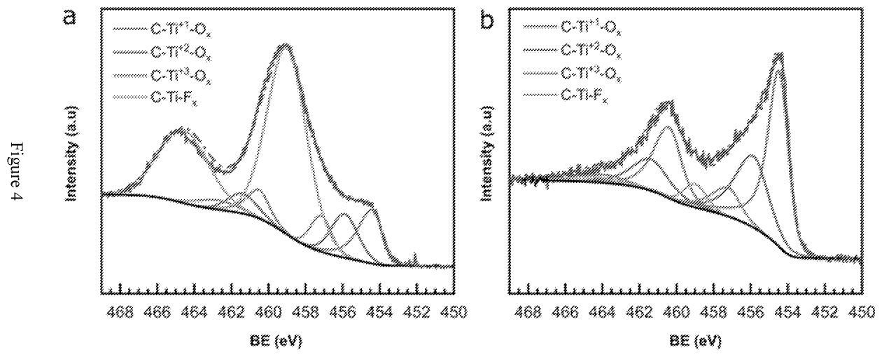

XPS analysis was carried out on the PC-MX samples investigate the surface groups that get attached to the MXene surface during this new etching procedure, the photoemission spectra of the Ti 2p region are plotted in FIG. 4. The red peaks are ascribed to the +1 oxidation state of the Ti atoms while the blue and green peaks correspond to the +2 and +3 oxidation states, respectively. The yellow peaks correspond to the —F terminations and are at a higher binding energy compared to the —O terminations because of bonding with highly electronegative F atoms. By quantifying the number of surface terminations present it is clear that the freshly synthesized MXene is mostly (≈70%) F-terminated and the remaining 30% are —O/—OH terminations. This is the highest fraction of F-terminations ever reported, and it is believed that the 30% —O/—OH terminations may result from the brief exposure to air and/or the dissociation of propanol during washing.

It is fairly well established in the MXene literature that F-terminations are less stable than their O counterparts. To confirm this conclusion, we rescanned the sample used to obtain the results shown in FIG. 4a, after exposure to the ambient atmosphere for 12 h. As seen in FIG. 4b, the atomic fraction of F-terminations drops to just 0.07. It follows that the benefits of F-terminations will only be realized if the filtered films are not exposed to the atmosphere. The loss of F-signal and the consistent with our assigning the peak around 459 eV to F. Had it been due to TiO₂, its intensity would have, if anything, increased upon exposure to air, rather than decreasing as observed. The details of the fittings and the exact peak positions is given in Table 2.

TABLE 2
Summary of XPS peak fits of spectra shown in FIG. 4 for PC-MX samples
right after washing and after 12 h exposure to ambient atmosphere.The
numbers in brackets in column 2 are peak locations for Ti 2p_{1/2} and
full width at half maximum (FWHM) values for Ti 2p_{1/2} peaks are in
brackets in column 3. The binding energy (BE) and the FWHM values for
the Ti 2p_{3/2} peaks are in column 2 and 3 respectively but outside
of the brackets.

| Sample | BE (eV) | FWHM (eV) | Fraction | Assigned To |
|---|---|---|---|---|
| PC-MX | 454.4 (460.5) | 1.2 (1.3) | 0.13 | C—Ti⁺¹—O_{z} |
| (fresh) | 455.9 (461.4) | 1.7 (1.9) | 0.11 | C—Ti⁺²—O_{z} |
| | 457.2 (462.7) | 1.3 (2.5) | 0.07 | C—Ti⁺³—O_{z} |
| | 459.0 (464.6) | 2.5 (3.2) | 0.69 | C—Ti—Fz |
| PC-MX | 455.4 (460.5) | 1.2 (1.6) | 0.51 | C—Ti⁺¹—O_{z} |
| (after | 455.9 (461.4) | 1.7 (2.3) | 0.30 | C—Ti⁺²—O_{z} |
| exposure to | 457.2 (462.7) | 1.4 (2.7) | 0.11 | C—Ti⁺³—O_{z} |
| air for 12 h) | 459.0 (464.6) | 1.5 (3.1) | 0.07 | C—Ti—F_{z} |

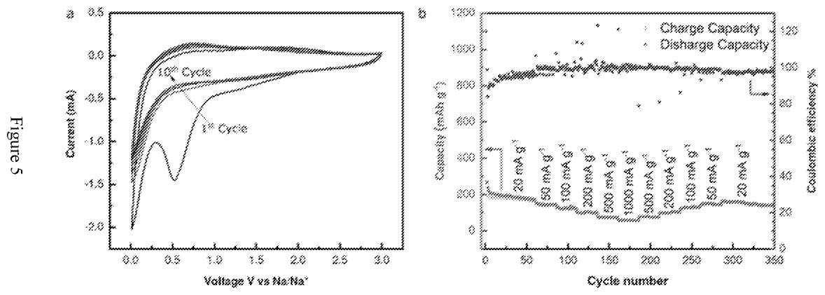

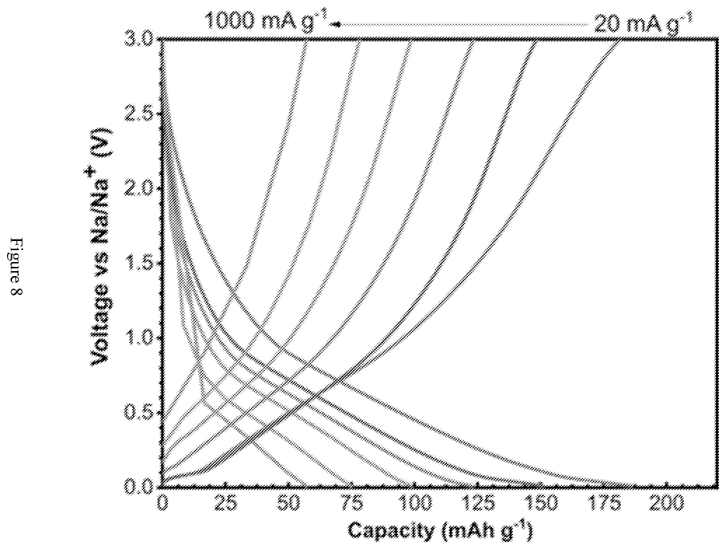

To demonstrate that etching in organic solvents can enhance MXene performance in some applications, we tested the PC-MX films as anodes in a Na-ion battery. This specific MXene sample was chosen because PC between the MXene layers may form a continuous interface between the MXene layers and the PC/EC electrolyte used in the Na-ion battery, possibly allowing easier diffusion of Na⁺ into the electrodes. To investigate Na-ion insertion—extraction behavior in PC-MX films, cyclic voltammetry (CV) and galvanostatic charge—discharge tests were performed (FIG. 8). The CV curves in FIG. 5a of the PC-MX electrode in the Na-ion electrolyte are similar to other MXene electrodes reported in literature.

In the first cathodic scan one irreversible reductive peak occurs at higher potentials (˜0.5 V), which is known to reflect the decomposition of the electrolyte and the formation of solid electrolyte interphase (SEI) on the surface of anode. Additionally, Na-ion insertion—extraction behavior is observed with sharp cathodic peak at lower potential region (0-0.2 V) and a broad anodic peak (0-1 V) can be clearly observed, these peaks are ascribed to the Na-intercalation into the conducting carbon added into the electrodes, but the capacity contribution from this conducting carbon is negligible as shown in our earlier reports.

A pair of small and broad redox peaks can be detected in a wide potential range of 1.2-2.5 V which can be ascribed to the surface redox reactions on the MXene surface. From the above discussion, we can infer that the working mechanism of PC-MX anode takes place in two stages. The reaction occurring at higher potential (1.2-2.5 V) range is attributed to the pseudocapacitve/surface redox charge transfer process on the surface of MXenes, while the reaction occurring at the narrow low potential range (0-0.2 V) is ascribed to Na-ion insertion—extraction in the conductive carbon additive. The slight pseudocapacitve/surface redox behavior observed in PC-MXene is attributed towards Na insertion in host stacked MXene and simultaneous charge transfer via a change in Ti oxidation states, to maintain charge neutrality.

Because in delaminated PX-MX stacking of the layers is weak and random due to which the pseudocapcitve/surface redox peaks are smaller in area, compared to reports where multilayered MXene was used. The pseudocapacitive contribution from the —F and —OH surface groups is negligible when MXene supercapacitors were tested in aprotic solvents electrolytes and the minor peaks arounds 1.0-1.5V were attributed to cation insertion between the weakly stacked MXene layers. Because PC is also an aprotic solvent, we can assume similar charge storage mechanism, which can also help explain the minor peaks at high voltage (1.2-2.5V) in our CV curves. After the first few cycles the CV curves almost overlap, suggesting the capacity decay mainly occurs in the initial cycles, and subsequently the electrode shows good Na ion insertion-extraction stability with minimal pseudocapcaitve/surface redox behavior.

FIG. 5b plots the cycling performance of PC-MX, as a function of current density starting at 20 mA g⁻¹. The capacity was initially found to be around 200 mAh g⁻¹ and with cycling it stabilized to around 160 mAh g⁻¹, which is one of the highest capacity values achieved for non-templated pure Ti₃C₂T_{z} (Table 3), proving that indeed etching and washing in organic solvents can nearly double the capacity of Na MXene anodes. Further, when tested at currents of 1000, 500, 200, 100, 50 mA g⁻¹ the capacities were found to be 60, 80, 100, 130, 150 mAh g⁻¹ respectively. The fact that nearly 40% of the original capacity is retained even when the current is increased 50 times, demonstrates that these materials can be used in high power and high energy Na batteries. The coulombic efficiency obtained was close to 99% for current 50 mA g 1 and above but drops to 98% at 20 mA g⁻¹, possibly due to parasitic reactions occurring at lower currents. It should be noted that the coulombic efficiency obtained here is also higher compared what was generally reported (≈95%) for Ti₃C₂T_{z} MXene electrodes, implying that PC between the layers leads to lesser parasitic reactions leading to better utilization of Na ions from the cathode.

The following table compares the performance of MXene materials made according to the present disclosure against the performance of other materials from the literature.

TABLE 3
Performance of materials according to the present disclosure.

| | Current density (mA | |
|---|---|---|
| Materials | g⁻¹) | Capacity (mAh g⁻¹) |
| This work | 20 | 200 |
| HCl induced | 20 | 200 |
| crumpled MXene | | |
| NaOH induced | 25 | 160 |
| crumpled MXene | | |
| LiOH induced | 25 | 270 |
| crumpled MXene | | |
| KOH induced | 25 | 150 |
| crumpled MXene | | |
| Multilayer MXene | 20 | 100 |
| MXene nanoribbons | 20 | 160 |
| Hollow MXene | 50 | 320 |
| spheres | | |

Additional Disclosure

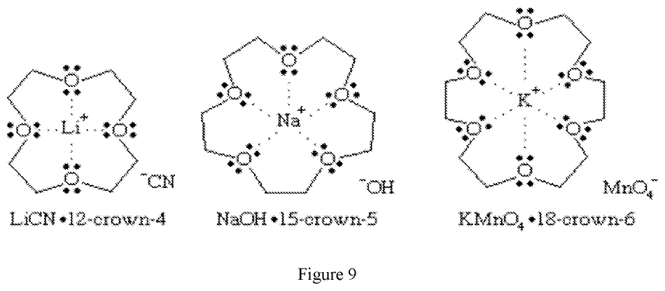

One can also utilize crown ethers (e.g., FIG. 9) to assist in etching MAX-phase materials to arrive at MXene materials. One such scheme is provided below, using an illustrative, non-limiting MAX phase material and also other illustrative, non-limiting participants:

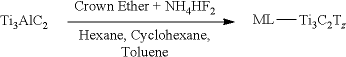

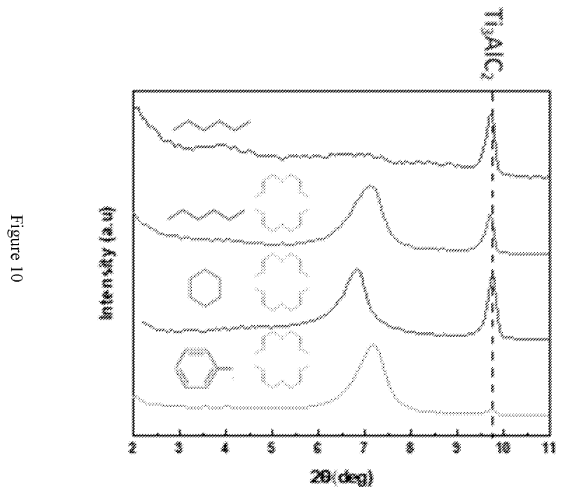

The above reaction provides an exemplary non-polar solvent etching route. Similar to the polar solvent etching, NH₄HF₂ is added to the non-polar solvent along with Ti₃AlC₂ MAX. Without being bound to any particular theory, to aid in solvation of the salt in the solvent, a crown ether (or “CE”) can also be added. The solution was stirred before washing and then analyzed using XRD (FIG. 10).

### SUMMARY

In conclusion, one can etch MAX compositions with a salt, a polar solvent and/or a non-polar solvent, and optionally a crown ether, and the etching can be performed in a water-free or essentially water-free manner. This method allows for the whole synthesis to be carried out in a glovebox, if needed, which was not possible earlier as water was mainly used as a solvent. This breakthrough, allows us to use MXenes in applications where the presence of even trace amounts of water is undesirable.

One of the possible advantages of etching in an organic solvent is that the synthesis can be done in a glovebox to make highly fluorinated MXenes, which can have significantly different optical, electronic and catalytic properties compared to 0-rich terminations.

Finally, it is shown that MXene processed according to the present disclosure (e.g., PC-Ti₃C₂T_{z}) shows nearly twice the capacity compared to comparable water-etched MXene, when tested as anodes in a Na-ion battery.

Lastly the use of low boiling point solvents, like acetonitrile, for etching can make it easy to recover back and purify the solvent for reuse, which can prove to be an important factor when considering industrial scale MXene synthesis.

### EMBODIMENTS

The following embodiments are exemplary only and do not limit the scope of the present disclosure or the appended claims.

Embodiment 1. A method of synthesizing a MXene material, the method comprising: contacting a MAX-phase material with an etchant, the MAX-phase material comprising elements M, A, and X and having the formula Mₙ₊₁AXₙ, the etchant being free of water, the etchant comprising (i) a salt, (ii) one or both of a polar solvent and a non-polar solvent, and optionally (iii) a crown ether, the contacting being performed under such conditions such that element A is removed from the MAX-phase material so as to give rise to a layered MXene material having the formula Mₙ₊₁XₙT_{z}.

Exemplary MXene compositions are provided in, e.g., PCT/US20/54912 (filed Oct. 9, 2020), as well as in U.S. patent application Ser. No. 14/094,966 (filed Dec. 3, 2013), 62/055,155 (filed Sep. 25, 2014), 62/214,380 (filed Sep. 4, 2015), 62/149,890 (filed Apr. 20, 2015), 62/127,907 (filed Mar. 4, 2015), or International Applications PCT/US2012/043273 (filed Jun. 20, 2012), PCT/US2013/072733 (filed Dec. 3, 2013), PCT/US2015/051588 (filed Sep. 23, 2015), PCT/US2016/020216 (filed Mar. 1, 2016), or PCT/US2016/028,354 (filed Apr. 20, 2016), preferably where the MXene composition comprises titanium and carbon (e.g., Ti₃C₂, Ti₂C, Mo₂TiC₂, etc.). Each of the foregoing is incorporated herein by reference in its entirety as if set forth verbatim herein, and is so incorporated for any and all purposes.

Suitable crown ethers include cyclic oligomers of ethylene oxide, the repeating unit being ethyleneoxy, i.e., —CH₂CH₂O—. Without being bound to any particular theory or embodiment, the oxygen atoms of crown ethers are well situated to coordinate with a cation located at the interior of the crown ether's ring, whereas the exterior of the ring can be hydrophobic. The resulting cations can form salts that are soluble in nonpolar solvents. The tetramer, pentamer, and hexamer members of the crown ether series are considered particularly useful, but other crown ethers can be used, e.g., 12-crown 4; 15-crown-5; 18-crown-6; dibenzo-18-crown-6; diaze-18-crown-6.

Embodiment 2. The method of Embodiment 1, wherein the salt comprises a halide. Sodium bifluoride, potassium bifluoride, lithium bifluoride, rubidium bifluoride, cesium bifluoride, and the like are exemplary such salts. The halide can be, e.g., a chloride, a bichloride, a fluoride, a bifluoride, an iodide, a biiodide, an astitide, a biastidide, and the like. The salt can be a non-halide, as well.

Embodiment 3. The method of Embodiment 2, wherein the halide comprises fluoride.

Embodiment 4. The method of any one of claims 1-3, wherein the etchant comprises a polar solvent.

Embodiment 5. The method of claim 4, wherein the polar solvent has a boiling point of less than 100 deg. C. This is not a requirement, as polar solvents having boiling points of greater than (or equal to) 100 deg. C. are also suitable. The polar solvent can be organic.

Embodiment 6. The method of any one of Embodiments 4-5, wherein the polar solvent comprises an alcohol, a carboxylic acid, an amine, an amide, a sulfur group, a ketone, an ester, an ether (including aliphatic ethers and cyclic ethers), an aldehyde, a lactone, or any combination thereof.

Embodiment 7. The method of any one of Embodiments 4-5, wherein the polar solvent comprises dichloromethane, N-methyl-2-pyrrolidone, tetrahydrofuran, ethyl acetate, acetone, dimethylformamide, acetonitrile, dimethyl sulfoxide, propylene carbonate, formic acid, n-butanol, isopropanol, nitromethane, ethanol, methanol, or any combination thereof.

Embodiment 8. The method of any one of claims 1-7, wherein the etchant comprises a non-polar solvent.

Embodiment 9. The method of claim 8, wherein the non-polar solvent comprises a linear chain hydrocarbon or a cyclic hydrocarbon. As some examples, the non-polar solvent can include hexane, heptane and other linear chain carbons. Other suitable non-polar solvents include cyclohexane, benzene, toluene, and other cyclic carbons, including aromatic carbons. A non-polar solvent can have a boiling point of less than 100 deg. C. This is not a requirement, as non-polar solvents having boiling points of greater than (or equal to) 100 deg. C. are also suitable. The non-polar solvent can be organic.

Still other exemplary non-polar solvents include (without limitation), e.g., dichloromethane, carbon disulfide, and other multielement molecules.

Embodiment 10. The method of any one of Embodiments 1-9, wherein the MAX-phase material comprises terminations T_{z}, and wherein the majority of the terminations T_{z} are halide terminations. The terminations can be, e.g., from 70-100% halide terminations, from 75 to 95% halide terminations, from 80 to 90% halide terminations, or even 85% halide terminations.

Embodiment 11. The method of any one of Embodiments 1-10, wherein the etchant is initially free of acid.

Embodiment 12. The method of any one of Embodiments 1-11, further comprising delaminating layers of the MXene material from one another. Delamination can be effected mechanically (e.g., via agitation, sonication, and the like), but can also be effected chemically.

Embodiment 13. The method of any one of Embodiments 1-12, further comprising recovering at least a portion of the one or both of a polar solvent and a non-polar solvent and, optionally, contacting the recovered one or both of a polar solvent and a non-polar solvent with MAX-phase material. In this way, one can reuse/recycle solvent in a batch and/or continuous process. Solvent can be recovered by, e.g., distillation, solvent-solvent extraction, and other techniques known to those of ordinary skill in the art.

Embodiment 14. The method of any one of Embodiments 1-13, wherein the MAX-phase material comprises Ti₃AlC₂, Ti₂AlC, or any combination thereof. As explained elsewhere herein, Ti—Al—C MAX-phase materials and MXene materials are illustrative only, and the disclosed technology is applicable to other MAX-phase and MXene materials.

Embodiment 15. A layered MXene material made according to any one of Embodiments 1-14.

Embodiment 16. The layered MXene material of Embodiment 15, wherein the layered MXene material is free of water. As an example, solvent can be provided water free and sealed under argon. Salt can be dried and placed in an argon filled glovebox, and reactions can be performed in a dry argon filled glovebox or other water-free environment.

Embodiment 17. The layered MXene material of any one of Embodiments 15-16, further comprising a plurality of ions inserted between layers of the layered MXene material. Such ions can be, e.g., lithium ions, sodium ions, cesium ions, ammonium ions, rubidium ions, and others.

Embodiment 18. The use of a layered MXene material according to any one of Embodiments 1-14.

Embodiment 19. A method, comprising effecting the reversible insertion of cations between layers of a layered MXene material made according to any one of Embodiments 1-14, the layered MXene material optionally in electronic communication with an electrical load.

Embodiment 20. The method of Embodiment 19, further effecting the reversible extraction of cations inserted between layers of a layered MXene material made according to any one of Embodiments 1-14, the layered MXene material optionally in electronic communication with an electrical load.

Embodiment 21. A system, comprising: a supply of a MAX-phase material; a supply of a salt; a supply of at least one of a polar solvent or a non-polar solvent; optionally, a supply of a crown ether; and a container configured to contain the MAX-phase material, the at least one of the polar solvent or the non-polar solvent, the optional crown ether, and the salt.

A system can be configured to operated in a batch, semi-batch, or a continuous manner. Such operation can include a process to recover solvent (polar or non-polar) for re-use.

Embodiment 22. The system of Embodiment 21, further comprising a recovery train configured to recover at least one of the polar solvent and the non-polar solvent.

Embodiment 23. An admixture, comprising an amount of a MAX-phase material; an amount of at least one of a polar solvent or a non-polar solvent; optionally, an amount of a crown ether; and an amount of a salt, the admixture optionally further comprising an amount of a layered MXene material, and the admixture being free of water.

### REFERENCES

The following references are provided for convenience.
M. Naguib, M. Kurtoglu, V. Presser, J. Lu, J. Niu, M. Heon, L. Hultman, Y. Gogotsi, M. W. Barsoum, Adv. Mater. 2011, 23, 4248.
L. Verger, C. Xu, V. Natu, H.-M. Cheng, W. Ren, M. W. Barsoum, Curr. Opin. Solid State Mater. Sci. 2019, DOI 10.1016/j.cossms.2019.02.001.
V. Natu, M. Clites, E. Pomerantseva, M. W. Barsoum, Mater. Res. Lett. 2018, 6, 230.
S. Intikhab, V. Natu, J. Li, Y. Li, Q. Tao, J. Rosen, M. W. Barsoum, J. Snyder, J. Catal. 2019, 371, 325.
S. J. Kim, H.-J. Koh, C. E. Ren, O. Kwon, K. Maleski, S.-Y. Cho, B. Anasori, C.-K. Kim, Y.-K. Choi, J. Kim, Y. Gogotsi, H.-T. Jung, ACS Nano 2018, 12, 986.
Y. Ying, Y. Liu, X. Wang, Y. Mao, W. Cao, P. Hu, X. Peng, ACS Appl. Mater. Interfaces 2015, 7, 1795.
M. Carey, Z. Hinton, M. Sokol, N. J. Alvarez, M. W. Barsoum, ACS Appl. Mater. Interfaces 2019, 11, 20425.
F. Shahzad, M. Alhabeb, C. B. Hatter, B. Anasori, S. Man Hong, C. M. Koo, Y. Gogotsi, Science (80-.). 2016, 353, 1137.
M. Sokol, V. Natu, S. Kota, M. W. Barsoum, Trends Chem. 2019, DOI 10.1016/j.trechm.2019.02.016.
T. Rackl, L. Eisenburger, R. Niklaus, D. Johrendt, Phys. Rev. Mater. 2019, 3, 054001.
M. Naguib, R. R. Unocic, B. L. Armstrong, J. Nanda, Dalt. Trans. 2015, 44, 9353.
M. Ghidiu, M. R. Lukatskaya, M.-Q. Zhao, Y. Gogotsi, M. W. Barsoum, Nature 2014, DOI 10.1038/nature13970.
T. Li, L. Yao, Q. Liu, J. Gu, R. Luo, J. Li, X. Yan, W. Wang, P. Liu, B. Chen, W. Zhang, W. Abbas, R. Naz, D. Zhang, Angew. Chemie 2018, DOI 10.1002/ange.201800887.
S. Yang, P. Zhang, F. Wang, A. G. Ricciardulli, M. R. Lohe, P. W. M. Blom, X. Feng, Angew. Chemie Int. Ed. 2018, DOI 10.1002/anie.201809662.
M. Li, J. Lu, K. Luo, Y. Li, K. Chang, K. Chen, J. Zhou, J. Rosen, L. Hultman, P. Eklund, P. O. A. Persson, S. Du, Z. Chai, Z. Huang, Q. Huang, J. Am. Chem. Soc. 2019, 141, 4730.
V. Natu, M. Sokol, L. Verger, M. W. Barsoum, J. Phys. Chem. C 2018, 122, 27745.
D. A. Vicic, G. D. Jones, in Compr. Organomet. Chem. III, Elsevier, 2007, pp. 197-218.
J. Isac-Garcia, J. A. Dobado, F. G. Calvo-Flores, H. Martinez-Garcia, in Exp. Org. Chem., Elsevier, 2016, pp. 353-370.
G. Laufersky, S. Bradley, E. Frecaut, M. Lein, T. Nann, Nanoscale 2018, 10, 8752.
K. Xu, Chem. Rev. 2014, 114, 11503.
P. Collini, S. Kota, A. D. Dillon, M. W. Barsoum, A. T. Fafarman, J. Electrochem. Soc. 2017, 164, D573.
M. Ghidiu, M. W. Barsoum, J. Am. Ceram. Soc. 2017, DOI 10.1111/jace.15124.
J. Halim, M. R. Lukatskaya, K. M. Cook, J. Lu, C. R. Smith, L.-A. Näslund, S. J. May, L. Hultman, Y. Gogotsi, P. Eklund, M. W. Barsoum, Chem. Mater. 2014, 26, 2374.
L. Verger, V. Natu, M. Ghidiu, M. W. Barsoum, J. Phys. Chem. C 2019, 123, 20044.
M. Ghidiu, J. Halim, S. Kota, D. Bish, Y. Gogotsi, M. W. Barsoum, Chem. Mater. 2016, 28, 3507.
S. Olejnik, A. M. Posner, J. P. Quirk, Clay Miner. 1970, 8, 421.
J. E. Gardolinski, P. Peralta-Zamora, F. Wypych, J. Colloid Interface Sci. 1999, 211, 137.
S. Olejnik, L. A. G. Aylmore, A. M. Posner, J. P. Quirk, J. Phys. Chem. 1968, 72, 241.
Y. Hirashima, H. Sato, A. Suzuki, Macromolecules 2005, 38, 9280.
Y.-Z. Zheng, N.-N. Wang, Y. Zhou, Z.-W. Yu, Phys. Chem. Chem. Phys. 2014, 16, 6946.
J. Halim, K. M. Cook, M. Naguib, P. Eklund, Y. Gogotsi, J. Rosen, M. W. Barsoum, Appl. Surf. Sci. 2016, 362, 406.
M.-Q. Zhao, X. Xie, C. E. Ren, T. Makaryan, B. Anasori, G. Wang, Y. Gogotsi, Adv. Mater. 2017, 1702410.
D. Zhao, M. Clites, G. Ying, S. Kota, J. Wang, V. Natu, X. Wang, E. Pomerantseva, M. Cao, M. W. Barsoum, Chem. Commun. 2018, DOI 10.1039/C₈CC00649K.
M. R. Lukatskaya, S.-M. Bak, X. Yu, X.-Q. Yang, M. W. Barsoum, Y. Gogotsi, Adv. Energy Mater. 2015, 5, 1500589.
S. Kajiyama, L. Szabova, K. Sodeyama, H. Iinuma, R. Morita, K. Gotoh, Y. Tateyama, M. Okubo, A. Yamada, ACS Nano 2016, 10, 3334.
N. Kurra, M. Alhabeb, K. Maleski, C.-H. Wang, H. N. Alshareef, Y. Gogotsi, ACS Energy Lett. 2018, 3, 2094.
Z. Lin, D. Barbara, P.-L. Taberna, K. L. Van Aken, B. Anasori, Y. Gogotsi, P. Simon, J. Power Sources 2016, 326, 575.
Y. Xie, Y. Dall′Agnese, M. Naguib, Y. Gogotsi, M. W. Barsoum, H. L. Zhuang, P. R. C. Kent, ACS Nano 2014, 8, 9606.
S. Li, P. Tuo, J. Xie, X. Zhang, J. Xu, J. Bao, B. Pan, Y. Xie, Nano Energy 2018, 47, 512.
T. Schultz, N. C. Frey, K. Hantanasirisakul, S. Park, S. J. May, V. B. Shenoy, Y. Gogotsi, N. Koch, Chem. Mater. 2019, acs. chemmater.9b00414.
G. R. Berdiyorov, AIP Adv. 2016, 6, 055105.
V. Natu, M. Clites, E. Pomerantseva, M. W. Barsoum, Mater. Res. Lett. 2018, 6, 230.
D. Zhao, M. Clites, G. Ying, S. Kota, J. Wang, V. Natu, X. Wang, E. Pomerantseva, M. Cao, M. W. Barsoum, Chem. Commun. 2018, DOI 10.1039/C₈CC00649K.
S. Kajiyama, L. Szabova, K. Sodeyama, H. Iinuma, R. Morita, K. Gotoh, Y. Tateyama, M. Okubo, A. Yamada, ACS Nano 2016, 10, 3334.
P. Lian, Y. Dong, Z.-S. Wu, S. Zheng, X. Wang, Sen Wang, C. Sun, J. Qin, X. Shi, X. Bao, Nano Energy 2017, 40, 1.
M.-Q. Zhao, X. Xie, C. E. Ren, T. Makaryan, B. Anasori, G. Wang, Y. Gogotsi, Adv. Mater. 2017, 1702410.

1. A method of synthesizing a MXene material, the method comprising:
contacting a MAX-phase material with an etchant,
the MAX-phase material comprising elements M, A, and X and having the formula Mₙ₊₁AXₙ,
the etchant being free of water,
the etchant comprising (i) a salt, (ii) one or both of a polar solvent and a non-polar solvent, and optionally (iii) a crown ether,
the contacting being performed under such conditions such that element A is removed from the MAX-phase material so as to give rise to a layered MXene material having the formula Mₙ₊₁XₙT_{z}.

2. The method of claim 1, wherein the salt comprises a halide.

3. The method of claim 2, wherein the halide comprises fluoride.

4. The method of claim 1, wherein the etchant comprises a polar solvent.

5. The method of claim 4, wherein the polar solvent has a boiling point of less than 100 deg. C.

6. The method of claim 1, wherein the polar solvent comprises an alcohol, a carboxylic acid, an amine, an amide, a sulfur group, a ketone, an ester, an ether an aldehyde, a lactone, or any combination thereof.

7. The method of claim 4, wherein the polar solvent comprises dichloromethane, N-methyl-2-pyrrolidone, tetrahydrofuran, ethyl acetate, acetone, dimethylformamide, acetonitrile, dimethyl sulfoxide, propylene carbonate, formic acid, n-butanol, isopropanol, nitromethane, ethanol, methanol, or any combination thereof.

8. The method of claim 1, wherein the etchant comprises a non-polar solvent.

9. The method of claim 8, wherein the non-polar solvent comprises a linear chain hydrocarbon or a cyclic hydrocarbon.

10. The method of claim 1, wherein the MAX-phase material comprises terminations T_{z}, and wherein the majority of the terminations T_{z} are halide terminations.

11. The method of claim 1, wherein the etchant is initially free of acid.

12. The method of claim 1, further comprising delaminating layers of the MXene material from one another.

13. The method of claim 1, further comprising recovering at least a portion of the one or both of a polar solvent and a non-polar solvent and, optionally, contacting the recovered one or both of a polar solvent and a non-polar solvent with MAX-phase material.

14. The method of claim 1, wherein the MAX-phase material comprises Ti₃AlC₂, Ti₂AlC, or any combination thereof.

15. A layered MXene material made according to claim 1.

16. The layered MXene material of claim 15, wherein the layered MXene material is free of water.

17. The layered MXene material of claim 15, further comprising a plurality of ions inserted between layers of the layered MXene material.

18. The use of a layered MXene material made according to claim 1.

19. A method, comprising effecting the reversible insertion of cations between layers of a layered MXene material made according to claim 1, the layered MXene material optionally in electronic communication with an electrical load.

20. The method of claim 19, further effecting the reversible extraction of cations inserted between layers of a layered MXene material made according to claim 1, the layered MXene material optionally in electronic communication with an electrical load.

21. A system, comprising:
a supply of a MAX-phase material; a supply of a salt;
a supply of at least one of a polar solvent or a non-polar solvent; optionally, a supply of a crown ether; and
a container configured to contain the MAX-phase material, the at least one of the polar solvent or the non-polar solvent, the optional crown ether, and the salt.

22. The system of claim 21, further comprising a recovery train configured to recover at least one of the polar solvent and the non-polar solvent.

23. An admixture, comprising:
an amount of a MAX-phase material;
an amount of at least one of a polar solvent or a non-polar solvent;
optionally, an amount of a crown ether; and
an amount off a salt,
the admixture optionally further comprising an amount of a layered MXene material,
and the admixture being free of water.
